(19) United States
(12) Patent Application Publication
(10) Pub. No.: US 2021/0389999 A1
(43) Pub. Date: Dec. 16, 2021

(54) ELECTRONIC NOTIFICATION FILTERING BASED ON INTELLIGENTLY IDENTIFIED FOCUS STATES

(71) Applicant: Microsoft Technology Licensing, LLC, Redmond, WA (US)

(72) Inventors: Sri Raghu Malireddi, Vancouver (CA); FNU Primadona, Redmond, WA (US); Arpita Verma, Bellevue, WA (US); Yoon Jae Choi, Bellevue, WA (US); Lei Yang, Redmond, WA (US); Dhaumya Vihang Mehta, Seattle, WA (US); Christina Chen Campbell, Redmond, WA (US); Micheal Dunn, Redmond, WA (US)

(21) Appl. No.: 16/985,417

(22) Filed: Aug. 5, 2020

Related U.S. Application Data
(60) Provisional application No. 63/038,865, filed on Jun. 14, 2020.

(51) Int. Cl. G06F 9/54; G06F 9/48; G06F 3/01; G06F 40/40; G06N 20/00

(52) U.S. Cl. CPC G06F 9/542; G06F 9/4831; G06F 2203/011; G06F 40/40; G06N 20/00; G06F 3/011

(57) ABSTRACT

In non-limiting examples of the present disclosure, systems, methods and devices for filtering notifications are provided. A notification may be received. A current focus state of a user may be determined. An application priority score for the application that generated the notification may be determined. A notification priority score for the notification may be determined. The notification priority score may be determined based on a contact importance score and/or a content importance score. A combined priority score may be determined from the application priority score and the notification priority score. The notification may be surfaced if the combined priority score meets a threshold surfacing value. The notification may be blocked if the combined priority score does not meet the threshold surfacing value.

### RELATED APPLICATIONS

This application is related to and claims priority to U.S. Provisional Patent Application No. 63/038,865, filed Jun. 14, 2020, and entitled “Electronic Notification Filtering Based on Intelligently Identified Focus States,” which is hereby incorporated by reference in its entirety.

### BACKGROUND

Technology today offers instant access to communications and information across many devices. However, with access to all that information there is a “noise” level created that can make it hard for users to stay focused and get work done. With the ever-increasing demands of professional and personal worlds, the constant distraction from ever-accessible devices has made it difficult to stay and concentrate on tasks at hand. Users are constantly interrupted by calls, notifications, emails, chats, and various other applications that distract and/or waste time. To attempt to stay focused in a multi device environment, users may turn off or completely silence distracting devices or use a blanket notification block that is far reaching for offending applications.

It is with respect to this general technical environment that aspects of the present technology disclosed herein have been contemplated. Furthermore, although a general environment has been discussed, it should be understood that the examples described herein should not be limited to the general environment identified in the background.

### SUMMARY

This summary is provided to introduce a selection of concepts in a simplified form that are further described below in the Detailed Description section. This summary is not intended to identify key features or essential features of the claimed subject matter, nor is it intended to be used as an aid in determining the scope of the claimed subject matter. Additional aspects, features, and/or advantages of examples will be set forth in part in the description which follows and, in part, will be apparent from the description or may be learned by practice of the disclosure.

Non-limiting examples of the present disclosure describe systems, methods and devices filtering electronic notifications. A focus state notification service may make a determination as to a current focus state of a user account. The current focus state may be a work focus state, a home focus state, or a vacation focus state, for example. The current focus state may be determined based on location data, application use data, contact data, activity data, and past user engagement data. A determination may be made that an electronic notification has been generated and/or received in association with the user account. The focus state notification service may determine an application priority score for the application that generated the notification, where the application priority score relates to the current focus state of the user account. The focus state notification service may further determine a notification priority score for the electronic notification. The notification priority score may be determined based on a contact importance score associated with the electronic notification and a content importance score associated with the electronic notification. The focus state notification service may determine a combined priority score based on the application priority score and the notification priority score. An activation function may be applied to the combined priority score, and a determination may be made as to whether the combined priority score meets a threshold surfacing value. If a determination is made that the combined priority score meets the threshold surfacing value, the electronic notification may be caused to be surfaced. Alternatively, if a determination is made that the combined priority score does not meet the threshold surfacing value, the electronic notification may be blocked from being surfaced.

### BRIEF DESCRIPTION OF THE DRAWINGS

Non-limiting and non-exhaustive examples are described with reference to the following figures:

FIG. 1 is a schematic diagram illustrating an example distributed computing environment for filtering electronic notifications based on a determined focus state.

FIG. 2 illustrates a computing environment for filtering notifications for surfacing in a device mirroring application on a first computing device that were originally received by a second computing device that is mirrored on the first computing device.

FIG. 3 illustrates a computing environment for filtering electronic notifications and surfacing an electronic notification that is not related to a current focus state.

FIG. 4 illustrates a simplified block diagram of a distributed computing environment for filtering electronic notifications based on a determined focus state.

FIG. 5 illustrates a simplified block diagram for determining application priority scores for an application and different focus states.

FIG. 6 illustrates a simplified block diagram for determining a contact importance score, a content importance score, a notification priority score, and a combined priority score.

FIG. 7 illustrates a simplified block diagram of a natural language processing model for determining a content importance score for an electronic notification.

FIG. 8A is an exemplary method for filtering electronic notifications based on a focus state.

FIG. 8B is an exemplary method for filtering electronic notifications for surfacing in work or home focus panes of a computing device.

FIG. 8C is an exemplary method for filtering electronic notifications for surfacing in a device mirroring application of a computing device.

FIGS. 9 and 10 are simplified diagrams of a mobile computing device with which aspects of the disclosure may be practiced.

FIG. 11 is a block diagram illustrating example physical components of a computing device with which aspects of the disclosure may be practiced.

FIG. 12 is a simplified block diagram of a distributed computing system in which aspects of the present disclosure may be practiced.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

Non-limiting examples of the present disclosure describe systems, methods and devices for filtering electronic notifications. A user account may associate one or more computing devices with a focus state notification service. The focus state notification service may reside and/or be executed entirely in the cloud, entirely on one or more local computing devices, or partially in the cloud and partially on one or more local computing devices. In some examples, the focus state notification service may determine whether to block electronic notifications from surfacing on one or more computing devices associated with a user account. In other examples, the focus state notification service may determine whether to segregate electronic notifications into one or more focus type panes on one or more computing devices (e.g., segregate work-related electronic notifications in a work focus pane of a computing device, segregate home-related electronic notifications in a home focus pane of a computing device). In still additional examples, the focus state notification service may determine whether to surface electronic notifications received by a first computing device in a device mirroring pane of a second computing device, where the device mirroring pane is mirroring the first computing device.

The focus state notification service may process data associated with a user account, one or more computing devices associated with that user account, and/or one or more applications associated with the user account. That data may include location data (e.g., computing device location while using certain applications, current device location, etc.), activity data (e.g., current user activity, what the user is doing in an application, what the user is doing in a computing shell construct, cross-device activity, whether a user is walking, whether a user is jogging, whether a user is driving), contacts data (e.g., identity of contacts associated with application, position of contacts in organization hierarchy, frequency of communication with contacts, whether a contact is identified as a family member, etc.), past user engagement data (e.g., past input in applications, past input in shell elements, past communications with contacts, etc.), and additional input data (e.g., user data indicating dismissal of notifications, user data indicating cross-focus state use of application, etc.). The focus state notification service may make a determination based on the processing of that data as to a current focus state of a user account. In some examples, the focus state may comprise one of a home focus state, a work focus state, or a vacation focus state. Other focus states may be determined and are in the scope of this disclosure. For example, the focus state notification service may determine that a user accounts is currently in an exercising focus state, a studying focus state, or a busy focus state.

The focus state notification service may receive an indication that an electronic notification has been received. In some examples, the indication may be received from an application service in the cloud. In other examples, the indication may be received when a local computing device receives the electronic notification. The focus state notification service may determine an application priority score for the application from which the electronic notification originated and/or by which the electronic notification was received. The application priority score that is determined for the application corresponds to the current focus state that was determined for the user account. The focus state notification service may determine a work focus state, home focus state, and/or vacation focus state application priority score based on current user interaction data with an application, past interaction data with an application, contact information (identities of contacts that send notifications to user account with application, organizational and/or social position of contact that sent notification to user account) associated with an application, and/or locational use data associated with an application while it is in use.

In some examples, the focus state application priority scores for an application may be pre-calculated prior to a new notification being received and those values may be updated over time based on user interactions. In additional examples, focus state application priority scores for an application may have default values assigned to them based on telemetry data for a plurality of users of the focus state notification service, and those default scores may be modified for specific user accounts over time based on the specific user accounts' interactions with the application.

The focus state notification service may additionally determine a notification priority score for an electronic notification. In examples, the notification priority score may be determined from a contact importance score and/or a content importance score.

A contact importance score may be determined based on determining an identity of a user account associated with an electronic notification. The user account may be a sender of a message corresponding to an electronic notification, a person included as recipient of a multi-user electronic message (e.g., a user included in the “to” field of an email, a user included in the “cc” field of an email), or the publisher of electronic content corresponding to an electronic notification (e.g., user that posted social media update corresponding to electronic notification, author of article corresponding to news update). In examples, users accounts that have a higher frequency of communication with one another may have higher contact importance scores associated with them. In additional examples, users accounts that are determined to be associated with a same group (e g, family account, work account, work organization) may have higher contact importance scores associated with them than user accounts that are not associated with a same group. In still additional examples, user accounts that are determined to be higher up in an organizational hierarchy, based on an organizational chart, may have higher contact importance scores associated with them than user accounts that are lower down in an organizational hierarchy.

A content importance score may be determined based on extraction of content (e.g., a message, a post) associated with an electronic notification and processing of that content. In examples, one or more natural language processing models may be applied to the content to determine a content importance score for content associated with an electronic notification. The one or more natural language processing models may comprise a keyword and/or key phrase matching model that matches the content associated with an electronic notification to one or more keywords or phrases that have been manually classified as being important or unimportant. In additional examples, a keyword and/or key phrase matching model may match keywords or phrases from the content to keywords or phrases that are known spam words or phrases. In other examples, the one or more natural language processing models may comprise a word, string, sentence, and/or document (e.g., entire content of notification/message) embedding model. Thus, one or more embeddings may be generated for text associated with an electronic notification, and similarity scores between those embeddings and one or more previously embedded words, strings, sentences, and/or documents in an embedding library may be determined. Thus, a determination may be made based on the similarity scores as to whether a newly generated embedding related to a new electronic notification is similar to previously generated embeddings that were classified as being important, unimportant, and/or relating to spam, for example. The embedding models that may be utilized may include one or more of: a Bidirectional Encoder Representations from Transformers (BERT) model, an Embeddings from Language Models (ELMo) model, a recurrent neural network (RNN) model, a long short-term memory (LSTM) model, and/or a gated recurrent units (GRU) model. In some examples a nearest neighbor model (e.g., KNN) may be utilized to determine similarity scores between embeddings.

The contact importance score and/or the content importance score may be processed to determine the notification priority score for an electronic notification. In examples, the processing may comprise applying one or more weighted or non-weighted functions to the contact importance score and/or the content importance score. In additional examples, one or more machine learning models may be applied to the contact importance score and/or content importance score to determine the notification priority score.

Upon determining an application priority score for a current focus state and a particular application from which an electronic notification was sent and/or received, and determining a notification priority score, the focus state notification service may determine a combined priority score for the electronic notification. In some examples, the combined priority score may be determined by calculating a weighted or non-weighted sum of the notification priority score and the application priority score. An activation function (e.g., softmax, sigmoid) may be applied to the sum to determine whether the combined priority score meets a threshold value for surfacing the notification. If a determination is made that the combined priority score for the electronic notification meets the surfacing threshold value, the focus state notification service may cause the electronic notification to be surfaced. Alternatively, if a determination is made that the combined priority score for the electronic notification does not meet the surfacing threshold value, the focus state notification service may block the electronic notification from being surfaced. In some examples, the focus state notification service may keep a log of electronic notifications that have been blocked while a user account is in a focus state. That log may be accessed and each of the electronic notifications may be surfaced so that a user can see which notifications have been blocked.

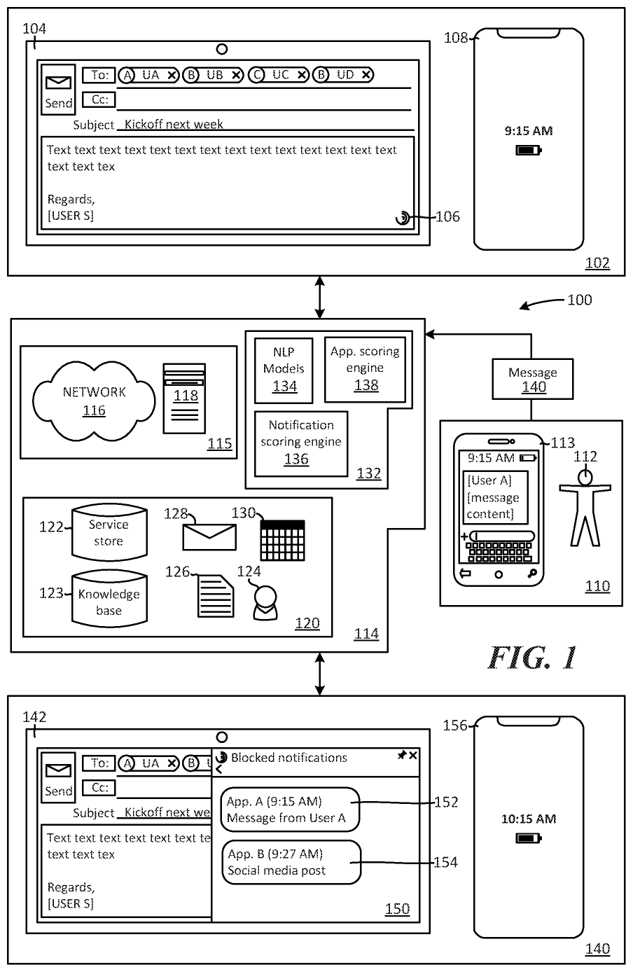

FIG. 1 is a schematic diagram illustrating an example distributed computing environment 100 for filtering electronic notifications based on a determined focus state. Computing environment 100 includes pre-notification sub-environment 102, post-notification sub-environment 140, focus state notification service sub-environment 114, and notification sending sub-environment 110.

Pre-notification sub-environment 102 includes computing device 104 and computing device 108. Post-notification sub-environment 140 includes computing device 142 and computing device 156. Computing devices 104 and 142 are the same computing device. Computing devices 108 and 156 are the same computing devices.

Focus state notification service sub-environment 114 includes network and processing sub-environment 115, service store 120, and machine learning sub-environment 132. Network and processing sub-environment 115 includes network 116, via which any and all of the computing devices described herein may communicate with one another, and server computing device 118. Server computing device 118 is illustrative of one or more server computing devices that may host a focus state notification service. Although the focus state notification service is primarily described herein as being cloud-based, the focus state notification service may reside and/or be executed all or in part on one or more local computing devices, such as computing device 104 and/or computing device 108. Machine learning sub-environment 132 includes natural language processing models 134, notification scoring engine 136, and application scoring engine 138.

Service store sub-environment 120 may include information associated with the focus state notification service and/or one or more applications or application services. For example, service store sub-environment may include application interaction data, contact interaction data, and/or organizational hierarchy data for one or more user accounts. The application interaction data may include a number of inputs received by one or more applications by user accounts, amount of time actively using one or more applications by user accounts, times of day and/or days of the week that user accounts utilize applications, identities of contacts communicated with utilizing applications, user and/or device location while utilizing one or more applications, and/or what activity (e.g., walking, talking, driving, meeting, etc.) a user is engaging in while utilizing one or more applications. The aggregate information for a plurality of users associated with a productivity application suite may be included in service store 122. Information that is particularly relevant to the focus state notification service (e.g., application usage data, location data, contact data) may be stored in knowledge base 123. In some examples, service store 122 and knowledge base 123 may be the same storage element.

In some examples, service store 122 may be associated with a plurality of user accounts, such as user account 124. User account 124 may have granted the focus state notification service with access to her application data. User account 124 may additionally or alternatively be associated with one or more productivity application services. In this example, user account 124 is associated with an email application service, a word processing application service, and a calendar application service. As such, service store 122 includes electronic messages 128 associated with user account 124, documents 126 associated with user account 124, and calendar information 130 associated with user account 124. Service store 122 may include additional information from one or more other applications, such as SMS messaging applications, group messaging/collaboration applications, task management applications, to-do list applications, map applications, reservation applications, presentation applications, and spreadsheet applications, for example.

The focus state notification service may monitor electronic notifications received by one or more computing devices (e.g., computing device 104, computing device 108) associated with a user account, and filter those electronic notifications to intelligently determine which electronic notifications to surface based on a user's current focus state. In additional examples, the focus state notification service may filter electronic notifications for surfacing in different focus panes (e.g., work focus pane, home focus pane), which may be contemporaneously open and/or executed on a computing device. In examples where the focus state notification service filters notifications for surfacing based on a user's current focus state, the focus state notification service may first identify a current focus state of a user. In examples, the current focus state associated with a user/user account may be determined to be a home focus state, a work focus state, or a vacation focus state. Other focus states may include an exercising focus state (e.g., on a run, at the gym) and a busy focus state (e.g., at the movies, on a phone call). The focus state notification service may analyze and/or process a plurality of signals from user account data associated with a user account to determine a current focus state for that user account. Those signals may be identified from service store 122 and/or knowledge base 123.

To determine a current focus state of a user account, the focus state notification service may analyze identities of one or more applications that are currently being utilized by a user, current interaction data associated with those one or more applications, past interaction with those one or more applications, current user activity, location data associated with one or more computing devices associated with the user account (e.g., where is the user current, where is the user going), and/or contact data associated with one or more applications that are currently being utilized. In some examples, the focus state notification service may analyze one or more documents (e.g., electronic calendar events, emails, text messages, travel reservations) with one or more natural language processing models to make a determination as to a location where a user currently is or where the user is going. The focus state notification service may apply weights to one or more of these data points and make a determination as to which focus state (e.g., work focus state, home focus state, vacation focus state) the user account is currently in. In other examples, the user account may manually set the current focus state, which may override an automatic determination that the focus state notification service may make in that regard.

If an electronic notification is received by one or more devices (e.g., computing device 104, computing device 108) associated with a user account, the focus state notifications service may determine an application priority score for the application from which the notification was sent and/or received. The focus state notification service may further determine a notification priority score for the electronic notification. The focus state notification service may then process and/or apply one or more functions to the application priority score for the application and the notification priority score for the electronic notification and make a determination as to a combined priority score for the electronic notification. If the combined priority score meets or exceeds a threshold value, the focus state notification service may cause the electronic notification to be surfaced. However, if the combined priority score does not meet or exceed the threshold value (e.g., the combined priority score is below the threshold value), the focus state notification service may cause the electronic notification to be blocked. Blocked notifications may be kept in a hidden list that may be accessed by a user at any time to determine what notifications have been blocked while in a given focus state.

The focus state notification service may determine a work focus state application priority score, a home focus state application priority score, and/or a vacation focus state application priority score for applications for which electronic notifications may be received. In examples, the focus state notification service may determine a work focus state, home focus state, and/or vacation focus state application priority score based on current user interaction data with an application, past interaction data with an application, contact information (identities of contacts that send notifications to user account with application, position of contact that sent notification to user account) associated with an application, and/or locational use data associated with an application while it is in use. The current user interaction data may comprise real-time or near real-time interaction with an application or interaction with an application during a current work/activity session (e.g., last 20 minutes, last 45 minutes). The application priority score determination may be performed by application scoring engine 138.

In some examples, the focus state application priority scores for an application may be pre-calculated prior to a new notification being received and those values may be updated over time based on user interactions. In additional examples, focus state application priority scores for an application may have default values assigned to them based on telemetry data for a plurality of users of the focus state notification service, and those default scores may be modified for specific user accounts over time based on the specific user accounts' interactions with the application.

Thus, an application priority score for an application (A) for a given focus state (F) may be determined by the focus state notification service. This may be mathematically represented as P(A|F). The focus state notification service may calculate these values by normalizing the user inputs (e.g., clicks) and interactions to a certain application's notifications with the total number of inputs/interactions of the different applications' notifications by the user along with signal weights from knowledge base 123 and/or service store 122.

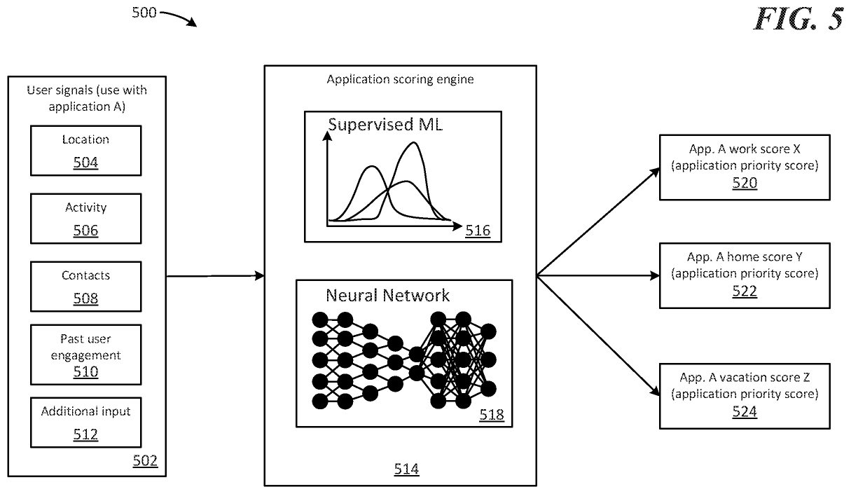

In some examples, the application priority scores may have a value from 0 to 1 based on an application's association with a corresponding focus state. For example, a word processing application may have a work focus state application priority score of 0.75 (likely relating to work focus state), a home focus state application priority score of 0.20 (unlikely as relating to home focus state), and a vacation focus state application priority score of 0.05 (very unlikely as relating to vacation state). Alternatively, an SMS messaging application may have a work focus state application priority score of 0.25 (unlikely as relating to work focus state), a home focus state application priority score of 0.70 (likely relating to home focus state), and a vacation focus state application priority score of 0.85 (very likely relating to home focus state). Thus, the focus state application priority scores may, but need not necessarily, add up to 1 (or 100%) between each of the focus states. For example, it may be extremely likely that a user account frequently accesses a web browser application in a work focus state and in a home focus state. According to some examples, an application priority score may be updated dynamically (e.g., to reflect user real-time need). For example, if a user is determined to be in a work focus state and an SMS messaging application/chat is opened, the work focus state application priority score for the SMS messaging application may be dynamically increased. Additional details related to focus state application priority scores are provided below in relation to FIG. 5.

Notification scoring engine 138 may perform operations associated with determining a notification priority score for an electronic message. In examples, the notification priority score may be determined from a contact importance score and/or a content importance score.

A contact importance score may be determined based on determining an identity of a user account associated with an electronic notification. The user account may be a sender of a message corresponding to an electronic notification, a user account included as recipient of a multi-user electronic message (e.g., a user included in the “to” field of an email, a user included in the “cc” field of an email), or the publisher of electronic content corresponding to an electronic notification (e.g., user that posted social media update corresponding to electronic notification). In examples, users accounts that have a higher frequency of communication with one another may have higher contact importance scores associated with them. In additional examples, users accounts that are determined to be associated with a same group (e g, family account, work account, work organization) may have higher contact importance scores associated with them than user accounts that are not associated with a same group. In still additional examples, user accounts that are determined to be higher up in an organizational hierarchy, based on an organizational chart, may have higher contact importance scores associated with them than user accounts that are lower down in an organizational hierarchy.

A content importance score may be determined based on extraction of content (e.g., a message, a post) associated with an electronic notification and processing of that content. In examples, natural language processing models 134 may be applied to the content to determine a content importance score for content associated with an electronic notification. Natural language processing models 134 may comprise a keyword and/or key phrase matching model that matches the content associated with an electronic notification to one or more important or unimportant keywords or phrases. In additional examples, a keyword and/or key phrase matching model may match keywords or phrases from the content to keywords or phrases that are known spam words or phrases. In other examples, natural language processing models 134 may comprise a word, string, sentence, and/or document (e.g., entire content of notification/message) embedding model. Thus, one or more embeddings may be generated for text associated with an electronic message, and similarity scores between those embeddings and one or more previously embedded words, strings, sentences, and/or documents may be determined. Thus, a determination may be made based on the similarity scores as to whether a newly generated embedding related to a new electronic notification is similar to previously generated embeddings that were classified as being important, unimportant, and/or relating to spam, for example. The embedding models that may be utilized may include one or more of: a BERT model, an ELMo model, a recurrent neural network model, a long short-term memory (LSTM) model, and/or a gated recurrent units (GRU) model. In some examples a nearest neighbor model may be utilized to determine similarity scores between embeddings.

In a specific example, raw notification content (\hat{D}) from an application/notification may be passed as a string data structure into a pre-processing phase. During pre-processing, the focus state notification service may remove unnecessary punctuation marks and unsupported non-unicode characters, convert the string to lowercase letters, and/or apply a word tokenizer. The result of the pre-processing phase may be a list of words (\tilde{D}) from the input notification content. The focus state notification service and/or natural language processing models 134 may maintain a list of stop words (S) which do not add any semantic value to the notification content, block words (B) which are most common words in spam notifications, and words of importance (I) which add a sense of urgency to the notification content. The stop words may be filtered from (\tilde{D}) to get \tilde{D}_{S}. This information may then be utilized to calculate the content importance score of the electronic notification. In examples, any block words (B) that were identified in the content associated with the electronic notification may cause the content importance score to be reduced, and any important words (I) that were identified in the content associated with the electronic notification may cause the content importance score to be increased. The normalized sum of word probabilities from \tilde{D}_{S} may be calculated to arrive at the content importance score for an electronic notification:

$$P ( D ) = P ( {\tilde{D}}_{S} ) = \frac{{Σ}_{i}^{N} P ( {w}_{i} )}{N} ,$$

where wᵢ ∈\tilde{D}_{S} and P(wᵢ) is word priority score

In examples, the content importance score and/or the contact importance score may be processed to determine the notification priority score for an electronic notification. The processing may comprise summing the scores, applying one or more weighted functions to the scores, and/or processing the scores with a neural network that has been trained to classify notification importance, for example.

Upon determining an application priority score for a current focus state and a particular application from which an electronic notification was sent and/or received, and determining a notification priority score for the electronic notification, the focus state notification service may determine a combined priority score for the electronic notification. This determination may be performed by notification scoring engine 136. In some examples, the combined priority score may be determined by calculating a weighted or non-weighted sum of the notification priority score and the application priority score. An activation function (e.g., softmax, sigmoid) may be applied to the sum to determine whether the combined priority score meets a threshold value for surfacing the notification.

As a specific example, the priority of a notification given a user's current focus state P(N|F) may be calculated as the weighted sum of P(A|F) and P(D):

P(N|F)=ω_{A}_{_{ƒ}}×P(A|F)+ω_{D}×P(D)

An activation function (ƒ) may then be utilized as a decision threshold for priority:

ƒ(P(N|F))⇒(Priority Notification,Not a priority)

The algorithm may evolve with user patterns and updates to the database (e.g., knowledge base 123, service store 122) with user preferences to recommend with higher confidence upon usage.

Turning to the illustrated example, computing device 104 and computing device 108 are both associated with a same user account. In some examples, computing device 104 and computing device 108 may be connected with one another (e.g., via Bluetooth, via a local area connection, via Wi-Fi, etc.). In other examples, computing device 104 and computing device 108 may share information (e.g., has notification been received, content of notification, identity of user account that sent notification, current focus state, etc.) with one another via a controller executed by the focus state notification service.

In this example, computing device 104 displays a word processing application that a user is actively engaged with. The word processing application has a draft email displayed that is addressed to four users in the “to” field, with the subject “Kickoff next week” and some text in the body of the email. The user account associated with computing device 103 and computing device 108 has granted the focus state notification service with access to her data in service store 122 and knowledge base 123 to block and/or filter electronic notifications.

Notification sending sub-environment 110 includes second user 112 and computing device 113. Second user 112 has a user account that is associated with computing device 113. That user account has sent message 140 to the user account associated with computing device 108. Computing device 104 may receive electronic notifications in relation to content received by computing device 108, such as message 140.

In this example, the focus state notification service determines that the user account associated with computing devices 104/108 is currently in a work focus state. The focus state notification service further determines an application priority score, based on the work focus state, for the messaging application that sent message 140. Focus state notification service additionally determines a notification priority score for the electronic notification. Based on the notification priority score associated with message 140, and the application priority score associated with message 140, the focus state notification service determines a combined priority score. A determination is then made that the combined priority score is below a surfacing threshold value. As such, the focus state notification service blocks the notification from being surfaced on computing device 104. In some examples, the focus state notification service may additionally or alternatively block the notification from being surfaced on computing device 108.

According to some examples, the focus state notification service may take into account a computing device's do not disturb (DND) status. For example, a DND setting associated with one or both of computing devices 142 and/or 156 may be set to on, and when a notification is received by computing device 156, the focus state notification service may automatically lower the application priority score for the notification or lower the combined priority score based on the DND status. In other examples, the focus state notification service may lower the application priority score for an application if the application has been manually muted.

In some examples, the focus state notification service may cause an indication that there are one or more blocked notifications to be surfaced in an application or shell construct associated with a device on which a user is currently engaged. In this example, blocked notification indication 106 is displayed in the word processing application. A user may interact with blocked notification indication 106 to cause the blocked notifications to be displayed. Thus, in this example, the user interacts with blocked notification indication 106.

Moving to post-notification sub-environment 140, based on the user's interaction with blocked notification indication 106, blocked notifications pane 150 is caused to be surfaced over the word processing application displayed on computing device 142. Specifically, blocked notifications pane 150 includes blocked notification 152, which corresponds to the electronic notification that was blocked in relation to message 140. Blocked notification 152 states “App. A (9:15 AM)—Message from User A”. Blocked notifications pane 150 also includes blocked notification 154 related to another electronic notification that was blocked from being surfaced. Blocked notification 154 states “App. B (9:27 AM)—Social media post”.

In some examples, rather than the focus state notification service blocking an electronic notification received by a first client device (e.g., computing device 156) from being surfaced on a second client device (e.g., computing device 142) at the first client device or the second client device, the electronic notification may block an electronic notification at the application service that generated the notification. For example, the focus state notification service may block message 140 at the message service in the cloud. In the example of a social media notification, the focus state notification service may block such notifications at the social media service prior to the social media service sending out the notifications.

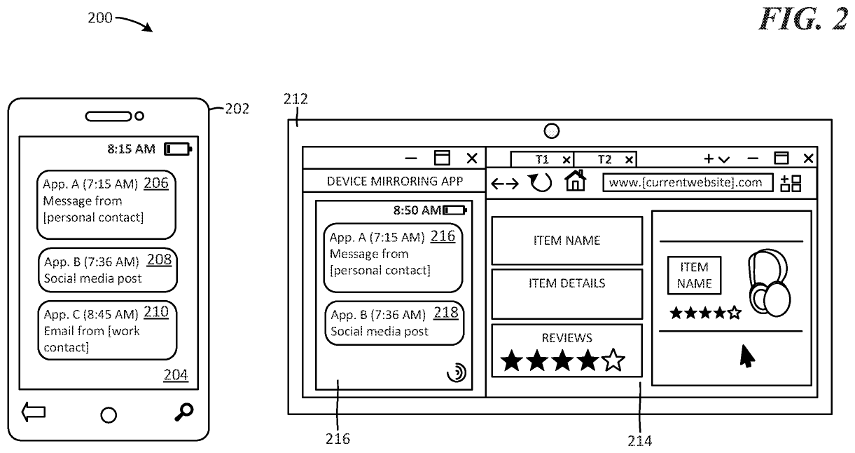

FIG. 2 illustrates a computing environment 200 for filtering notifications for surfacing in a device mirroring application on a first computing device 212 that were originally received by a second computing device 202 that is mirrored on the first computing device. Computing device 212 and/or computing device 202 may execute a device mirroring application that allows computing device 212 to display content (e.g., electronic notifications, applications, contact lists) from computing device 202 in device mirroring pane 216 of computing device 212. Computing device 202 and computing device 212 may be connected (e.g., via Bluetooth, via WiFi, via local area connection, etc.) and they share data with one another (e.g., electronic notification data, application data, current display data, etc.). Interactions with elements from computing device 202 in device mirroring pane 216 may be received, and those interactions may cause operations to be performed by computing device 202, which may result in new or updated information to be displayed in device mirroring pane 216 and/or on computing device 202.

The focus state notification service may be associated with one or both of computing devices 202 and/or 212. In some examples, a user account may be utilized to sign into computing device 202 and/or computing device 212 and/or one or more services associated with those computing devices, and the focus state notifications service may be associated with the user account. The user account may have provided the focus state notification service with access to the user's data (e.g., application data, contact list, etc.) and the focus state notification service may utilize that information to filter electronic notifications for one or both of computing devices 202 and/or 212.

In this example, a user is currently active on computing device 212. Specifically, web browser application 214 is open on computing device 212. Web browser application 214 displays an item (headphones) that the user is currently shopping for on an online retail website. Computing device 202 receives electronic notifications for three different applications/services. Specifically, computing device 202 receives first electronic notification 206 at 7:15 AM from application A, which is a message from [personal contact]; second electronic notification 208 at 7:36 AM from application B, which indicates that there is a new social media post the user might be interested in; and third notification 210 at 8:45 AM, which is an email notification from [work contact].

As each electronic notification is received, the focus state notification service may determine a current focus state of the user account (e.g., the user of computing device 212 and computing device 202), determine an application priority score for the application from which the electronic notification was received (based on the current focus state), determine a notification priority score for the electronic notification, determine a combined priority score from the application priority score and the notification priority score, and cause the electronic notification to be surfaced in the device mirroring application if the combined priority score meets a threshold surfacing value, or block the electronic notification if the combined priority score does not meet the threshold surfacing value.

The focus state notification service has determined that the user account was in a home focus state when each of notifications 206, 208 and 210 were received. The focus state notification service has determined that the combined priority score for first electronic notification 206 meets the surfacing threshold value, and as such, the electronic notification is caused to be surfaced in the device mirroring application, as illustrated by first mirrored electronic notification 216 in device mirroring pane 216. The focus state notification service has determined that the combined priority score for second electronic notification 208 meets the surfacing threshold value, and as such, the electronic notification is caused to be surfaced in the device mirroring application, as illustrated by second mirrored electronic notification 218 in device mirroring pane 216. The focus state notification service has determined that third electronic notification 210 does not meet the surfacing threshold value, and as such, third electronic notification 210 is blocked from being surfaced in device mirroring pane 216 of the device mirroring application.

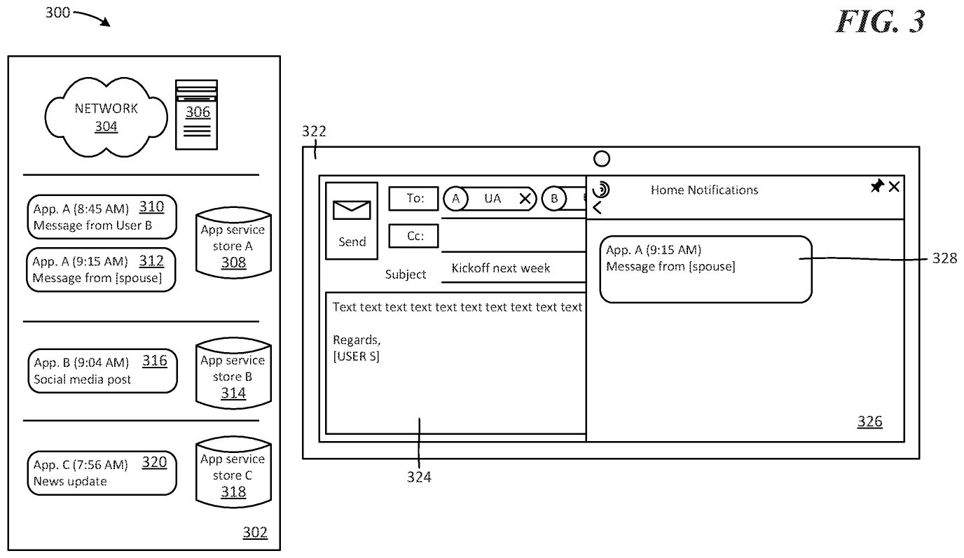

FIG. 3 illustrates a computing environment 300 for filtering electronic notifications and surfacing an electronic notification that is not related to a current focus state. Computing environment 300 includes application service store sub-environment 302 and computing device 322.

Application service store sub-environment 302 includes network 304 and server computing device 306. Computing device 322 may communicate with any of the application services described herein via network 304. Server computing device 306 is illustrative of a server computing device which may host one or more of the application services described herein and/or the focus state notification service. Application service store sub-environment 302 further includes application service store A 308, which may host data associated with application A (e.g., a messaging application service); application service store B 314, which may host data associated with application B (e.g., a social media application service); and application service store C 318, which may host data associated with application C (e.g., a news application service).

Computing device 322 and/or a user account associated with computing device 322 may have subscribed and/or allowed each of the application services illustrated in application service store sub-environment 302 to surface electronic notifications on computing device 322. The user account associated with computing device 322 may have provided the focus state notification service with access to the user's data (e.g., application data, contact list, etc.) and the focus state notification service may utilize that information to filter electronic notifications in relation to computing device 322 and/or the application services included in application service sub-environment 302.

In this example, there are two electronic notifications generated by the application service associated with application service store A 308. Specifically, first electronic notification 310 was generated at 8:45 AM and is a message from User B; and electronic notification 312 was generated at 9:15 AM and is a message from [spouse]. There is one electronic notification generated by the application service associated with application service store B 314. Specifically, third electronic notification 316 was generated at 9:04 AM, which indicates that there is a new social media post that the user might be interested in. There is also one electronic notification generated by the application service associated with application service store C 318. Specifically, fourth electronic notification 320 was generated at 7:56 AM, which indicates that there is a news update that the user might be interested in.

The focus state notification service may receive an indication from each of the application services when a new notification is generated for the user account associated with computing device 322. The focus state notification service may then determine a current focus state of the user account (e.g., the user of computing device 322), determine an application priority score (based on the current focus state) for the application (e.g., application service) that generated the electronic notification, determine a notification priority score for the electronic notification, determine a combined priority score from the application priority score and the notification priority score, and cause the electronic notification to be surfaced by computing device 322 if the combined priority score meets a threshold surfacing value, or block the electronic notification from being surfaced by computing device 322 if the combined priority score does not meet the threshold surfacing value.

The focus state notification service has made a determination that when each of the notifications illustrated in service store sub-environment 302 were generated, the user account associated with 322 was in a work focus state. The focus state may have been determined based on the location of computing device 322, the application the user was accessing (e.g., electronic mail application 324), content being worked on in electronic mail application 324, contacts that are included in electronic mail application 324, past interactions with the application the user was accessing, and/or the time of day, for example. Each of the electronic notifications that were generated in service store sub-environment 302 may primarily relate to a home focus state. Additionally, each of the application services that generated those electronic notifications may primarily relate to a home focus state. However, a contact importance score and/or content importance score for electronic notification 312 may have been relatively high such that the combined priority score for electronic notification 312 met the threshold surfacing value. As such, the focus state notification service causes home notification pane 326 to be displayed, which includes electronic message 312 surfaced as break-through electronic notification 328. Each of the other electronic notifications were blocked as their combined priority scores did not meet the surfacing threshold value.

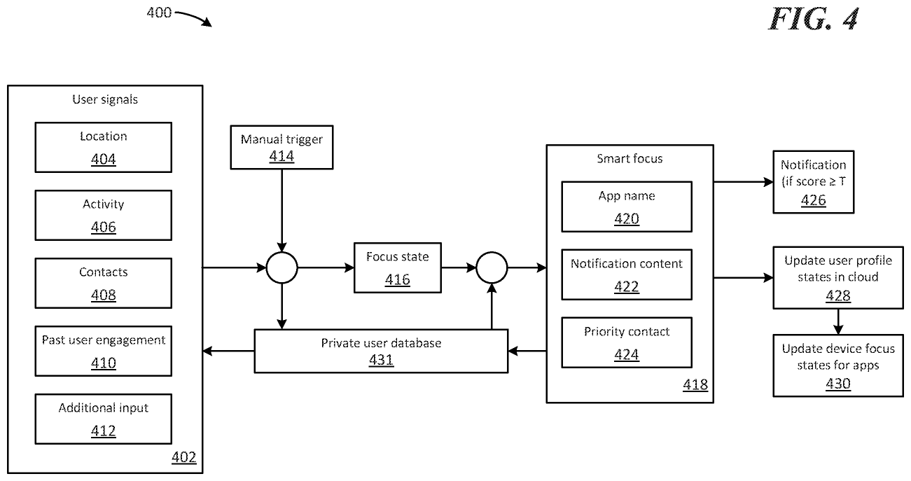

FIG. 4 illustrates a simplified block diagram of a distributed computing environment 400 for filtering electronic notifications based on a determined focus state. Distributed computing environment 400 includes user signals element 402, comprising location data 404, activity data 406, contacts data 408, past user engagement data 410, and additional input data 412. Distributed computing environment 400 further includes manual trigger element 414, focus state element 416, private user database element 431, notification element 426, update user profile states in cloud element 428, and update device focus states for applications element 430. Distributed computing environment also includes application name data 420, notification content data 422, and priority contact data 424.

User signals element 402 illustrates various user signals, such as location data 404 (e.g., computing device location), activity data 406 (e.g., current user activity, what the user is doing in an application, in a computing shell construct, cross-device, walking, jogging, driving), contacts data 408 (e.g., identity of contacts associated with application, position of contacts in organization hierarchy, frequency of communication with contacts, whether a contact is identified as a family member, etc.), past user engagement data 410 (e.g., past input in applications, past input in shell elements, past communications with contacts, etc.), and additional input data 412 (e.g., user data indicating dismissal of notifications, user data indicating cross-focus state use of application, etc.). The focus state notification service may process that data and determine a current focus state of a user (e.g., a user account). The focus state notification service may adapt the model used to determine the focus state utilizing a user account's personal preferences, while also providing a manual trigger for the user to select a desired focus state. This is illustrated by manual trigger element 414. The focus state that is determined automatically or via manual input is illustrated by focus state element 416.

Smart focus state element 418 illustrates a multi-stage machine learning model that may use information from an electronic notification, such as an application name (e.g., application name element 420), notification content (e.g., notification content element 422), and/or contact information (e.g., priority contact element 424) to determine a notification priority score for an electronic notification and/or an application priority score associated with an application or service that generated or received an electronic notification. A weighted or non-weighted function may be applied to the notification priority score and/or the application priority score to determine a combined priority score for an electronic notification. The combined priority score may be passed through a learnt activation function to predict whether to surface an electronic notification.

Notification element 426 illustrates that an electronic notification may be surfaced if the combined priority score is determined to meet a threshold value. Alternatively, an electronic notification may be blocked if the combined priority score is determined to be below a threshold value.

Private user database element 431 is illustrative of a private database that collects and stores all of the necessary information about a user account without intruding on the privacy of a user. The information collected and/or included in the private database may include: user clicks or interactions for notifications from different applications, user response rate to different contacts, manual triggers from user for desired focus state, and/or manual triggers for notification preferences. The user interactions in relation to notifications and response rate to different contacts may train the model to provide better recommendations with respect to notification priority to the user. This continuous learning flow may thus adapt to user preference changes over time. This is illustrated by update user profile states in cloud element 428 and update device focus states for applications element 430. In some examples, a user profile state in the cloud may inform the application presence states in an application on one or more associated computing devices. For example, a group communication application may obtain user profile state scores for “work only” or “work focus”, etc. The group communication application may then reflect combined presence plus focus information as a single presence state (e.g., “focusing at work”).

FIG. 5 illustrates a simplified block diagram 500 for determining application priority scores for an application and different focus states. Diagram 500 includes user signals 502, application scoring engine 514, application A work focus state score 520, application A home focus state score 520, and application A vacation focus state score 524.

User signals 502 are illustrative of various data relating to an application (application A) that are utilized by the focus state notification service to generate scores for the application in relation to different focus states. That is, the focus state notification service may utilize one or more of user signals 502 in relation to an application that generates electronic notifications as to how likely it is that those notifications relate to a user's work focus state, home focus state, and/or vacation focus state (or other focus states if they exist). Location data 404 is illustrative of device location when a user utilizes application A or interacts with notifications from application A. Activity data 506 is illustrative of an activity status of a user when the user utilizes application A or interacts with notifications from application A. Contacts data 508 is illustrative of the relationship that contacts communicated with utilizing application A have to a work focus state, a home focus state, and/or a vacation focus state. Past user engagement data 510 is illustrative of past user engagement (e.g., time spent using, clicks, inputs, etc.) with application A in a work focus state, a home focus state, and/or a vacation focus state. Additional input data 512 is illustrative of a user's history of dismissing notifications of application A while in a work focus state, a home focus state, and/or a vacation focus state and/or miscellaneous signals that a user may have in relation to application A.

Application scoring engine 514 may process one or more data points from user signals 502 with one or more machine learning models, such as supervised machine learning model 516 and/or neural network 518 to determine focus state scores for an application (e.g., application A). Supervised machine learning model 516 may be a logistic regression machine learning model that has been trained to calculate focus state scores based on application data and/or user input data. Neural network 518 may receive vectorized inputs generated from application data and/or user input data and classify that data as relating to one or more focus states.

In this example, a first score for application A and its relationship to a work focus state is determined for a user account. That score is illustrated by application A work score 520 (e.g., score X). A second score for application A and its relationship to a home focus state is determined for the user account. That score is illustrated by application A home score 522 (e.g., score Y). A third score for application A and its relationship to a vacation focus state is determined for the user account. That score is illustrated by application A vacation score 524 (e.g., score Z). Each of those scores are application priority scores, which may be processed in association with a notification priority score for an electronic notification to determine a combine priority score for the electronic notification, and subsequently to determine whether to surface or block the electronic notification.

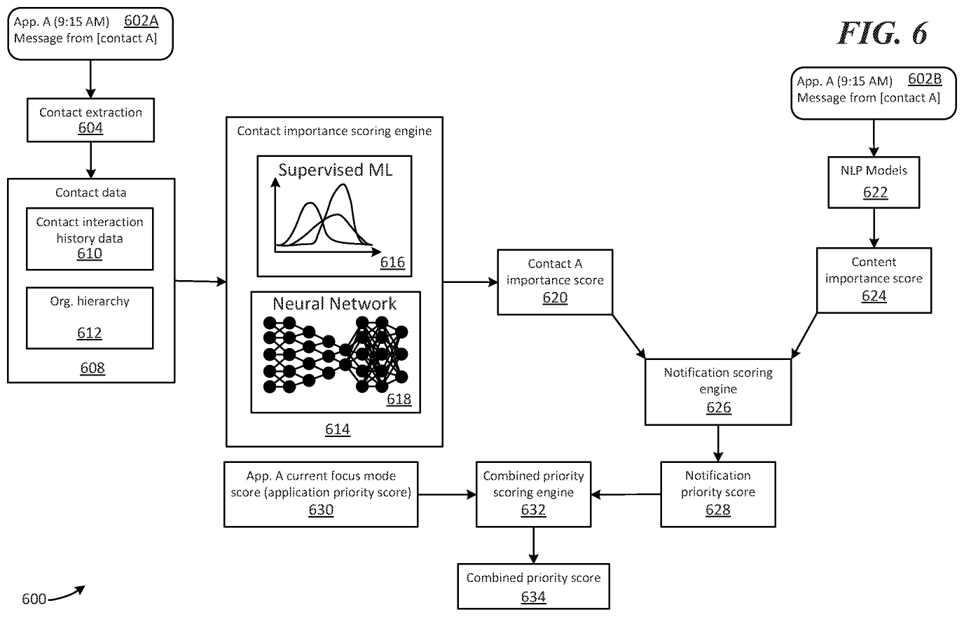

FIG. 6 illustrates a simplified block diagram 600 for determining a contact importance score, a content importance score, a notification priority score, and a combined priority score associated with an electronic notification. Block diagram 600 includes electronic notification 602A and electronic notification 602B, which are the same electronic notification. Electronic notification 602A/602B is an electronic notification generated by application A at 9:15 AM, which is a message from [contact A].

Contact information from electronic notification 602A may be extracted and analyzed as illustrated by contact extraction element 604. For example, contact data element 608 illustrates that the identity of the sender (e.g., [contact A]) of the electronic message corresponding to electronic notification 602A, which is extracted at contact extraction element 604, may be analyzed to identity contact interaction history data 610 and a position of [contact A] in organizational hierarchy 612. Contact interaction history data 610 may comprise communication history between [contact A] and the user account for which a determination is being made as to whether to surface electronic notification 602A (e.g., the receiver of the message).

Contact data 608 may be processed by one or more machine learning models, as illustrated by contact importance scoring engine 614, which includes supervised machine learning model 616, and neural network 618. A contact importance score may be determined based on that processing, as illustrated by contact A importance score 620.

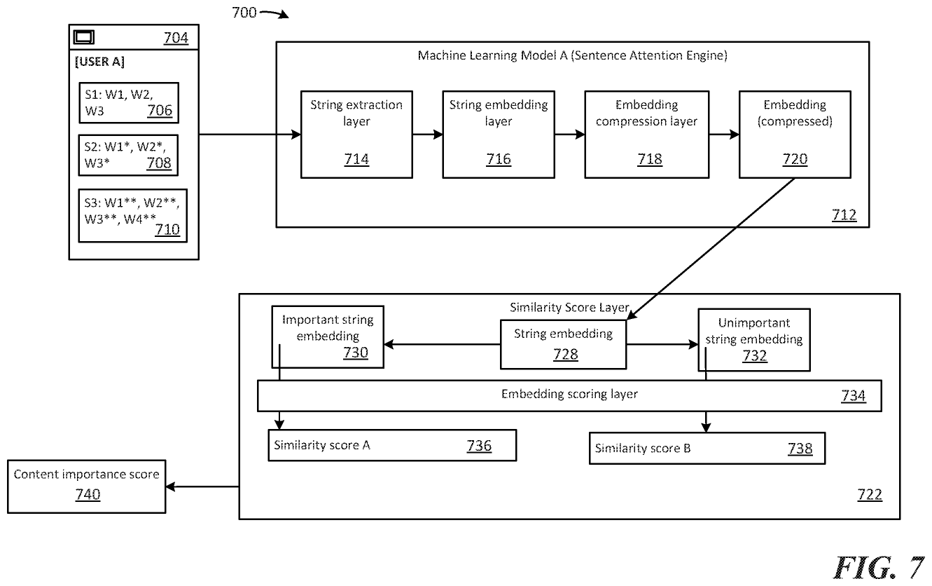

Moving to the right side of block diagram 600, textual content from electronic notification 602B and/or textual content associated with electronic notification 602B (e.g., the text from the corresponding message, the text associated with a social media post for a social media notification) may be extracted and processed. In some examples, the text may be preprocessed (e.g., identification of strings, converting strings to lowercase letters, application of word tokenizer), and further processed by one or more natural language processing models, as illustrated by natural language processing models element 622. Natural language processing models 622 may comprise keyword or phrase matching models that match keywords or phrases from electronic notification 602B (or from the message itself) to important keywords or phrases, spam keywords or phrases, or unimportant keywords or phrases. In other examples, natural language processing models 622 may comprise an embedding model in which determinations are made as to similarity scores in relation to important, unimportant, and/or spam embeddings. An exemplary embedding model is more fully discussed below in relation to FIG. 7.

The result of the processing performed at natural language processing models element 622 is a content importance score, as illustrated by content importance score element 624. A notification priority score is then determined from contact A importance score 620 and content importance score 624, as illustrated by notification scoring engine 626 and resulting notification priority score element 628. One or more weighted or non-weighted functions or machine learning models are then applied to an application priority score corresponding to the application that generated electronic notification 602A/602B and the current focus state, illustrated by application A current focus state score element 630. The application of the one or more weighted or non-weighted functions or machine learning models to the application priority score and the notification priority score is illustrated by combined priority scoring engine 632. The combined priority score is thus determined by combined priority scoring engine 632, as illustrated by combined priority score element 634.

FIG. 7 illustrates a simplified block diagram 700 of a natural language processing model for determining a content importance score for an electronic notification. Block diagram 700 includes electronic notification 702, which is a message notification from [user A] to a user account associated with the focus state notification service. Electronic notification 704 and/or the message associated with electronic notification 704 includes the identity of the sending user ([user A]) and textual content that includes three text strings, first string 706, second string 708, and third string 710.

The textual content of electronic notification 704 (or from the message itself) is processed by machine learning model A 712, which may comprise a sentence attention model. Each of the three text strings are extracted by string extraction layer 714. From string extraction layer 714, the strings are passed to string embedding layer 716. String embedding layer 716 comprises a language embedding model. The language embedding model creates an embedding for each string. The language embedding model may comprise a contextual embedding model (e.g., a BERT model, an ELMo model, a recurrent neural network model, a long short term memory (LSTM) model, a gated recurrent units (GRU) model). In some examples, string embedding layer 716 may combine the embeddings from one or more strings into an overall embedding for an electronic notification or its corresponding textual content (e.g., message content, social media post content, news article content, etc.).

The embeddings generated at string embedding layer 716 may be passed to embedding compression layer 718. Embedding compression layer 718 may comprise a model for transforming a continuous embedding generated for a string by string embedding layer 716 into a binary form. As examples, embedding compression layer 718 may comprise one or more of: a direct binarization with a hard threshold model, reducing the dimensionality with either a random projection or principal component analysis model, and/or an encoding-decoding framework with an additional semantic-preserving loss model.

The compressed (binary) embedding for each string (or the embedding for the message as a whole) is represented by compressed embedding element 720. The embedding for a string (or the embedding for the message as a whole) is represented in a compressed or uncompressed form as string embedding 728 in similarity score layer 722. The embedding is incorporated in an embedding library comprised of a plurality of language embeddings for other textual content (e.g., important string embedding 730, unimportant string embedding 732). The embedding library includes previously embedded text, and those embeddings may be associated with an importance classification, an unimportance classification, and/or a spam classification. In some examples, a plurality of the embeddings in similarity score layer 722 may have been manually classified as important, unimportant, and/or as spam, and one or more new embeddings may have been automatically classified as important, unimportant, or as spam based on their similarity scores in relation to the manually classified embeddings.

Similarity scores may be calculated via application of a similarity score model to the new embeddings from the newly embedded strings, and one or more of the embeddings from the embedding library (e.g., important string embedding 730, unimportant string embedding 732). In some examples, the similarity score model may be a cosine model. In other examples, the similarity score model may be a Hamming model. In this example, this is illustrated by similarity score layer 734.

A similarity score may be calculated between each embedded string (or the embedding for the message as a whole) and an embedding for important string embedding 730. The scoring and calculation are illustrated by embedding scoring layer 734. Thus, a similarity score, such as similarity score A 736, may be calculated for one or more of the strings associated with electronic notification 704 and important string embedding 730.

A similarity score may also be calculated between each embedded string (or the embedding for the message as a whole) and an embedding for unimportant string embedding 732. The scoring and calculation are illustrated by embedding scoring layer 734. Thus, a similarity score, such as similarity score B 738, may be calculated for one or more strings associated with electronic notification 704 and unimportant string embedding 732.

A determination may be made based on the similarity scores for the embedded strings of electronic notification 704 as to how important the content of electronic notification 704 (or message corresponding to electronic notification 704) is likely to be to the user. This importance is illustrated by content importance score 740, which may be a score calculated from one or more similarity scores, such as similarity score A 736 and/or similarity score B 738.

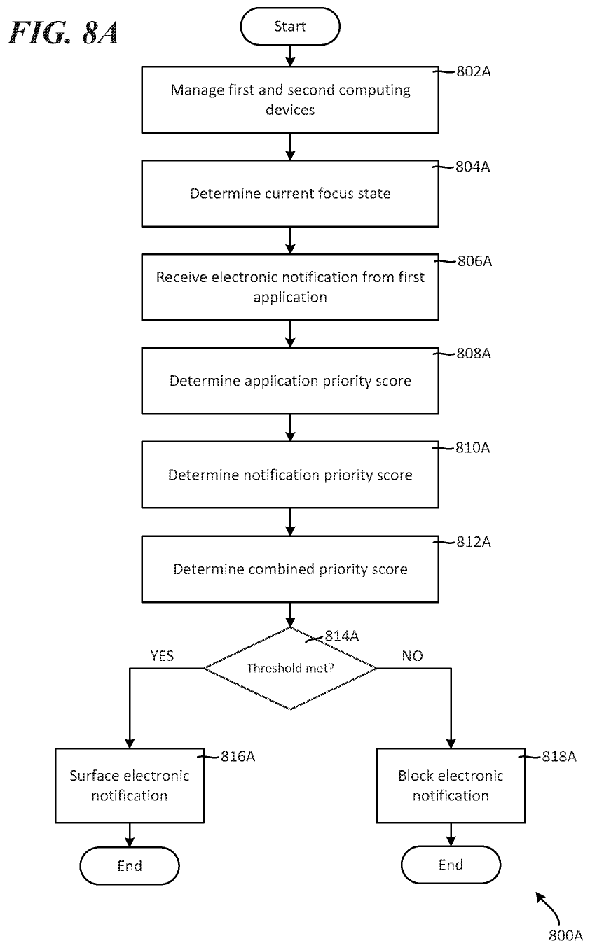

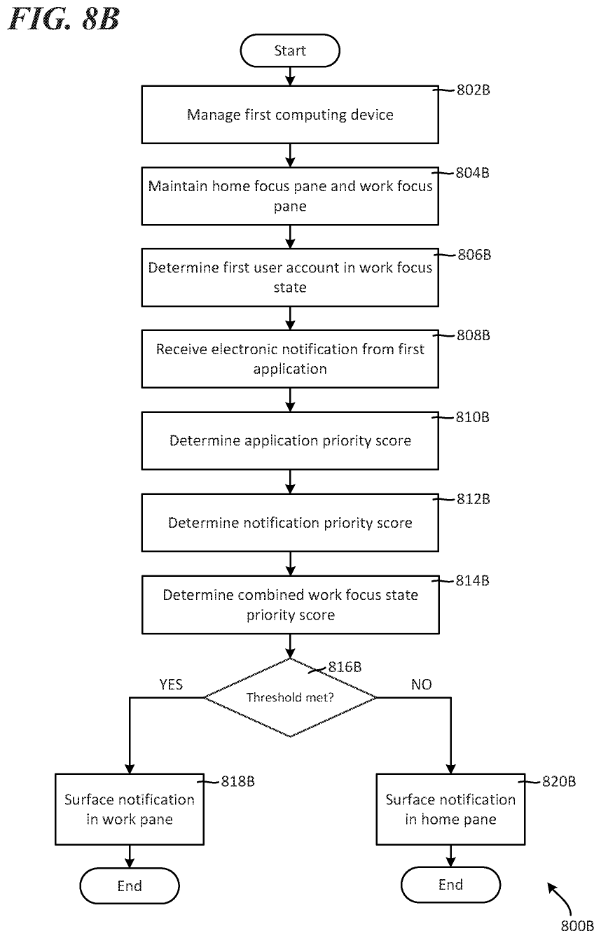

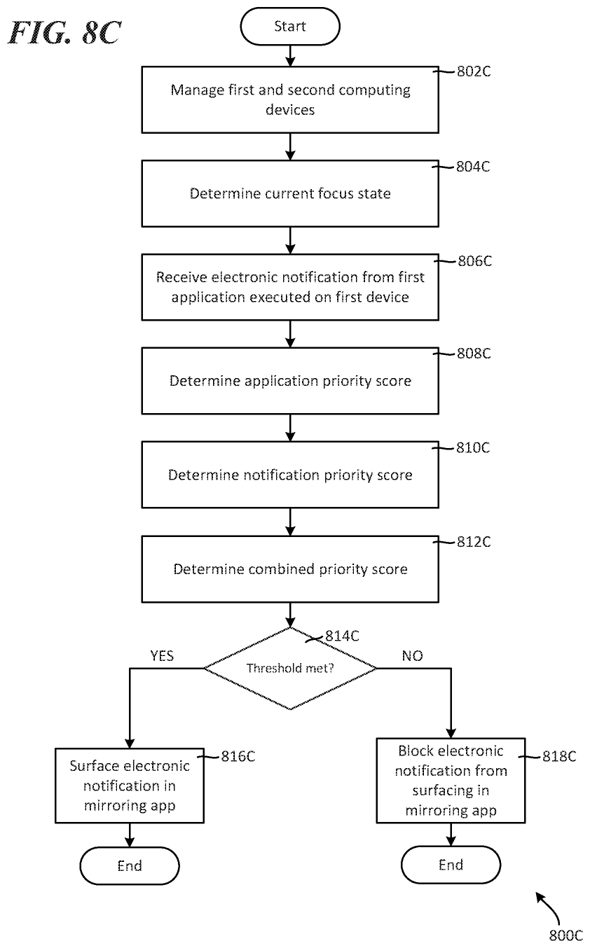

FIG. 8A is an exemplary method 800A for filtering electronic notifications based on a focus state. The method 800A begins at a start operation and flow moves to operation 802A.

At operation 802A a first computing device and a second computing device associated with a first user account are managed. The first computing device and the second computing device may be managed by a central controller of a focus state notification service. The focus state notification service may reside and/or be executed entirely in the cloud, entirely on local computing devices (e.g., on the first computing device, on the second computing device), and/or partially in the cloud and partially on one or more local computing devices.

From operation 802A flow continues to operation 804A where a current focus state associated with the first user account is determined. The current focus state may be determined based on processing of data associated with the user account, data associated with one or more computing devices associated with the user account, and/or one or more applications associated with the user account. The data may include location data, activity data, contacts data, past user engagement data, and/or additional input data. The current focus state may comprise a work focus state, a home focus state, or a vacation focus state. Other focus states are contemplated (e.g., exercising focus state, busy focus state).

From operation 804A flow continues to operation 806A where an electronic notification is received from a first application executed on the first computing device. The electronic notification may be received by the focus state notification service in the cloud and/or on the first computing device. The electronic notification may comprise an SMS message, a social media service notification, a news service notification, and/or a productivity application notification, for example.

From operation 806A flow continues to operation 808A where an application priority score for the first application is determined based, at least in part, on the current focus state. For example, the focus state notification service may determine a work focus state, home focus state, and/or vacation focus state application priority score for applications based on current user interaction data with an application, past interaction data with an application, contact information (identities of contacts that send notifications to user account with application, organizational and/or social position of contact that sent notification to user account) associated with an application, and/or locational use data associated with an application while it is in use. Thus, depending on the determined current focus state associated with the first user account, the application priority score for the first application may be different.

From operation 808A flow continues to operation 810A where a notification priority score for the electronic notification is determined. The notification priority score may be determined from a contact importance score associated with a sender/author/poster associated with the notification and/or a content importance score associated with the content of the notification.

From operation 810A flow continues to operation 812A where a combined priority score is determined from the first application priority score and the notification priority score. In some examples, the combined priority score may be determined by calculating a weighted or non-weighted sum of the notification priority score and the application priority score.

From operation 812A flow continues to operation 814A where a determination is made as to whether the combined priority score meets a threshold surfacing value. An activation function (e.g., softmax, sigmoid) may be applied to the weighted or non-weighted sum of the notification priority score and the application priority score to determine whether the combined priority score meets a threshold value for surfacing the notification.

If a determination is made at operation 814A that the combined priority score meets the threshold surfacing value, flow continues to operation 816A where the electronic notification is caused to be surfaced.

From operation 816A flow continues to an end operation and the method 800A ends.

Alternatively, if a determination is made at operation 814A that the combined priority score does not meet the threshold surfacing value, flow continues to operation 818A where the electronic notification is blocked.

From operation 818A flow continues to an end operation and the method 800A ends.

FIG. 8B is an exemplary method 800B for filtering electronic notifications for surfacing in work or home focus panes of a computing device. The method 800B begins at a start operation and flow moves to operation 802B.

At operation 802B a first computing device associated with a first user account is managed. The first computing device may be managed by a central controller of a focus state notification service. The focus state notification service may reside and/or be executed entirely in the cloud, entirely on local computing devices (e.g., on the first computing device), and/or partially in the cloud and partially on one or more local computing devices.

From operation 802B flow continues to operation 804B where a home focus pane and a work focus pane are maintained by the first computing device. The home focus pane may comprise a window or other user experience element in which home-related (or non-work-related) notifications are surfaced. The work focus pane may comprise a window or other user experience element in which work-related (or non-home-related) notifications are surfaced. In some examples, the home focus pane may include applications being executed that are primarily home focused, and the work focus pane may include applications being executed that are primarily work focused.

From operation 804B flow continues to operation 806B where a determination is made that the first user account is currently in a work focus state. That determination may be made based on processing od data associated with the first user account, data associated with one or more computing devices associated with the first user account, and/or one or more applications associated with the first user account. The data may include location data, activity data, contacts data, past user engagement data, and/or additional input data.

From operation 806B flow continues to operation 808B where an electronic notification is received from a first application. The electronic notification may be received by the focus state notification service in the cloud and/or on the first computing device. The electronic notification may comprise an SMS message, a social media service notification, a news service notification, and/or a productivity application notification, for example.

From operation 808B flow continues to operation 810B where a work focus state application priority score for the first application is determined. The work focus state application priority score for the first application may comprise a metric and/or value that is indicative of how important the application is to the first user account while the first user account (e.g., the user associated with the first user account) is determined to be in a work focus state. The work focus state application priority score for the first application may be determined at the time the electronic notification is received, or the work focus state application priority score for the first application may have been determined prior to the electronic notification being received.

From operation 810B flow continues to operation 812B where a notification priority score for the electronic notification is determined. The notification priority score may be determined from a contact importance score associated with the sender/author/poster associated with the notification and/or a content importance score associated with the content of the notification.

From operation 812B flow continues to operation 814B where a combined work focus state priority score for the electronic notification is determined. The combined work focus state priority score may be calculated from the work focus state application priority score for the first application and the notification priority score for the electronic notification. In some examples, the combined work focus state priority score for the electronic notification may be determined by calculating a weighted or non-weighted sum of the notification priority score for the electronic notification and the work focus state application priority score for the first application.

From operation 814B flow continues to operation 816B where a determination is made as to whether the combined work focus state priority score meets a threshold surfacing value for the work focus state. An activation function (e.g., softmax, sigmoid) may be applied to the weighted or non-weighted sum of the notification priority score for the electronic notification and the work focus state application priority score to determine whether the combined priority score meets a threshold value for surfacing the notification.

If a determination is made at operation 814B that the combined work focus state priority score meets the threshold surfacing value for the work focus state, flow continues to operation 818B. At operation 818B the electronic notification is caused to be surfaced in the work focus pane.

From operation 818B flow continues to an end operation and the method 800B ends.

Alternatively, if a determination is made at operation 814B that the combined work focus state priority score does not meet the threshold surfacing value for the work focus state, flow continues to operation 820B. At operation 820B the electronic notification is caused to be surfaced in the home focus pane.

From operation 820B flow continues to an end operation and the method 800B ends.

FIG. 8C is an exemplary method 800C for filtering electronic notifications for surfacing in a device mirroring application of a computing device. The method 800C begins at a start operation and flow moves to operation 802C.

At operation 802C a first computing device associated with a first user account, and a second computing device associated with the first user account, are managed. The second computing device may be executing a device mirroring application that mirrors the first computing device. The first computing device and the second computing device may be managed by a central controller of a focus state notification service. The focus state notification service may reside and/or be executed entirely in the cloud, entirely on local computing devices (e.g., on the first computing device, on the second computing device), and/or partially in the cloud and partially on one or more local computing devices.

From operation 802C flow continues to operation 804C where a current focus state associated with the first user account is determined. The current focus state may be determined based on processing of data associated with the user account, data associated with one or more computing devices associated with the user account, and/or one or more applications associated with the user account. The data may include location data, activity data, contacts data, past user engagement data, and/or additional input data. The current focus state may comprise a work focus state, a home focus state, or a vacation focus state. Other focus states are contemplated (e.g., exercising focus state, busy focus state).

From operation 804C flow continues to operation 806C where an electronic notification is received from a first application executed on the first computing device. The electronic notification may be received by the focus state notification service in the cloud and/or on the first computing device. The electronic notification may comprise an SMS message, a social media service notification, a news service notification, and/or a productivity application notification, for example.

From operation 806C flow continues to operation 808C where an application priority score for the first application is determined based, at least in part on the current focus state. For example, the focus state notification service may determine a work focus state, home focus state, and/or vacation focus state application priority score for applications based on current user interaction data with an application, past interaction data with an application, contact information (identities of contacts that send notifications to user account with application, organizational and/or social position of contact that sent notification to user account) associated with an application, and/or locational use data associated with an application while it is in use. Thus, depending on the determined current focus state associated with the first user account, the application priority score for the first application may be different.

From operation 808C flow continues to operation 810C where a notification priority score for the content of the electronic notification is determined. The notification priority score may be determined from a contact importance score associated with a sender/author/poster associated with the notification and/or a content importance score associated with the content of the notification.

From operation 810C flow continues to operation 812C where a combined priority score is determined from the first application priority score and the notification priority score. In some examples, the combined priority score may be determined by calculating a weighted or non-weighted sum of the notification priority score and the application priority score.

From operation 812C flow continues to operation 814C where a determination is made as to whether the combined priority score meets a threshold surfacing value. An activation function (e.g., softmax, sigmoid) may be applied to the weighted or non-weighted sum of the notification priority score and the application priority score to determine whether the combined priority score meets a threshold value for surfacing the notification.

If a determination is made at operation 814C that the combined priority score meets the threshold surfacing value, flow continues to operation 816C. At operation 816C the electronic notification is caused to be surfaced by the device mirroring application on the second computing device.

From operation 816C flow moves to an end operation and the method 800C ends.

Alternatively, if a determination is made at operation 814C that the combined priority score does not meet the threshold surfacing value, flow continues to operation 818C. At operation 818C the electronic notification is blocked from being surfaced by the device mirroring application on the second computing device.

From operation 818C flow moves to an end operation and the method 800C ends.

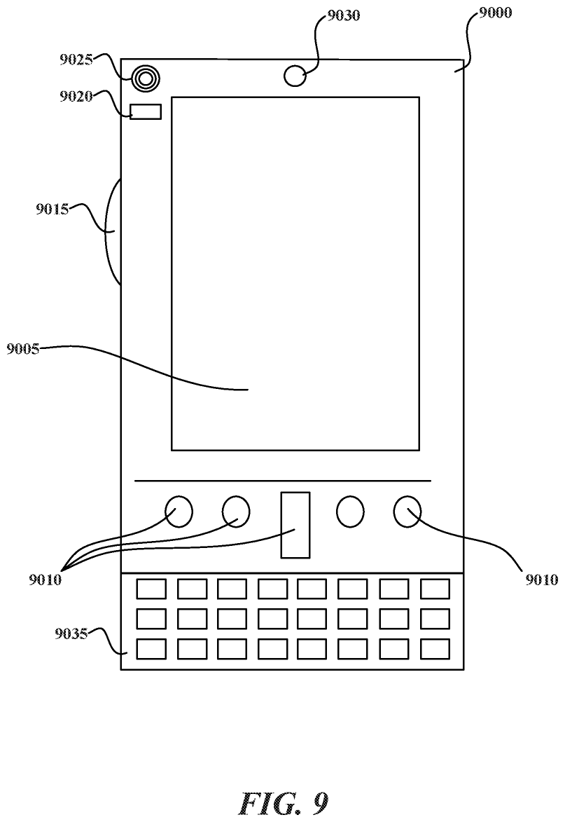

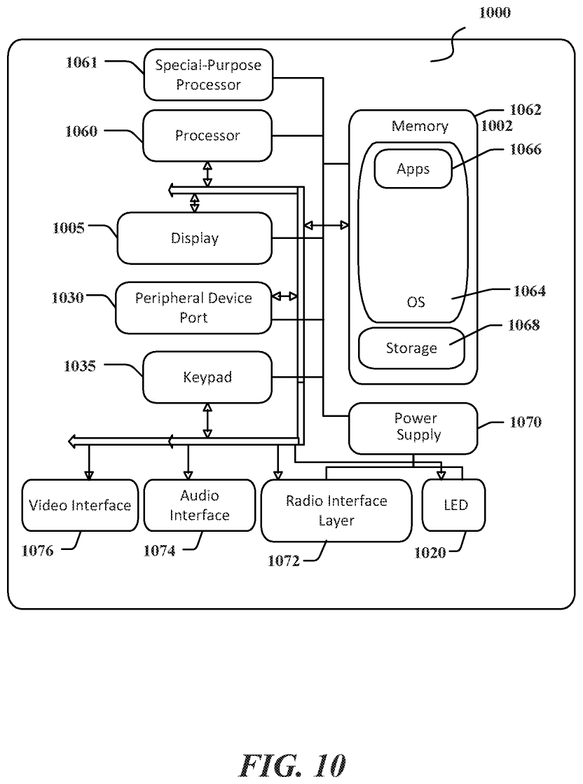

FIGS. 9 and 10 illustrate a mobile computing device 900, for example, a mobile telephone, a smart phone, wearable computer (such as smart eyeglasses), a tablet computer, an e-reader, a laptop computer, or other AR compatible computing device, with which embodiments of the disclosure may be practiced. With reference to FIG. 9, one aspect of a mobile computing device 900 for implementing the aspects is illustrated. In a basic configuration, the mobile computing device 900 is a handheld computer having both input elements and output elements. The mobile computing device 900 typically includes a display 905 and one or more input buttons 910 that allow the user to enter information into the mobile computing device 900. The display 905 of the mobile computing device 900 may also function as an input device (e.g., a touch screen display). If included, an optional side input element 915 allows further user input. The side input element 915 may be a rotary switch, a button, or any other type of manual input element. In alternative aspects, mobile computing device 900 may incorporate more or fewer input elements. For example, the display 905 may not be a touch screen in some embodiments. In yet another alternative embodiment, the mobile computing device 900 is a portable phone system, such as a cellular phone. The mobile computing device 900 may also include an optional keypad 935. Optional keypad 935 may be a physical keypad or a “soft” keypad generated on the touch screen display. In various embodiments, the output elements include the display 905 for showing a graphical user interface (GUI), a visual indicator 920 (e.g., a light emitting diode), and/or an audio transducer 925 (e.g., a speaker). In some aspects, the mobile computing device 900 incorporates a vibration transducer for providing the user with tactile feedback. In yet another aspect, the mobile computing device 900 incorporates input and/or output ports, such as an audio input (e.g., a microphone jack), an audio output (e.g., a headphone jack), and a video output (e.g., a HDMI port) for sending signals to or receiving signals from an external device.

FIG. 10 is a block diagram illustrating the architecture of one aspect of a mobile computing device. That is, the mobile computing device 1000 can incorporate a system (e.g., an architecture) 1002 to implement some aspects. In one embodiment, the system 1002 is implemented as a “smart phone” capable of running one or more applications (e.g., browser, e-mail, calendaring, contact managers, messaging clients, games, and media clients/players). In some aspects, the system 1002 is integrated as a computing device, such as an integrated personal digital assistant (PDA) and wireless phone.

One or more application programs 1066 may be loaded into the memory 1062 and run on or in association with the operating system 1064. Examples of the application programs include phone dialer programs, e-mail programs, personal information management (PIM) programs, word processing programs, spreadsheet programs, Internet browser programs, messaging programs, and so forth. The system 1002 also includes a non-volatile storage area 1068 within the memory 1062. The non-volatile storage area 1068 may be used to store persistent information that should not be lost if the system 1002 is powered down. The application programs 1066 may use and store information in the non-volatile storage area 1068, such as e-mail or other messages used by an e-mail application, and the like. A synchronization application (not shown) also resides on the system 1002 and is programmed to interact with a corresponding synchronization application resident on a host computer to keep the information stored in the non-volatile storage area 1068 synchronized with corresponding information stored at the host computer. As should be appreciated, other applications may be loaded into the memory 1062 and run on the mobile computing device 1000, including instructions for providing and operating a focus state notification platform.

The system 1002 has a power supply 1070, which may be implemented as one or more batteries. The power supply 1070 might further include an external power source, such as an AC adapter or a powered docking cradle that supplements or recharges the batteries.

The system 1002 may also include a radio interface layer 1072 that performs the function of transmitting and receiving radio frequency communications. The radio interface layer 1072 facilitates wireless connectivity between the system 1002 and the “outside world,” via a communications carrier or service provider. Transmissions to and from the radio interface layer 1072 are conducted under control of the operating system 1064. In other words, communications received by the radio interface layer 1072 may be disseminated to the application programs 1066 via the operating system 1064, and vice versa.

The visual indicator 920 may be used to provide visual notifications, and/or an audio interface 1074 may be used for producing audible notifications via the audio transducer 925. In the illustrated embodiment, the visual indicator 920 is a light emitting diode (LED) and the audio transducer 925 is a speaker. These devices may be directly coupled to the power supply 1070 so that when activated, they remain on for a duration dictated by the notification mechanism even though the processor 1060 and other components might shut down for conserving battery power. The LED may be programmed to remain on indefinitely until the user takes action to indicate the powered-on status of the device. The audio interface 1074 is used to provide audible signals to and receive audible signals from the user. For example, in addition to being coupled to the audio transducer 925, the audio interface 1074 may also be coupled to a microphone to receive audible input, such as to facilitate a telephone conversation. In accordance with embodiments of the present disclosure, the microphone may also serve as an audio sensor to facilitate control of notifications, as will be described below. The system 1002 may further include a video interface 1076 that enables an operation of an on-board camera 930 to record still images, video stream, and the like.

A mobile computing device 1000 implementing the system 1002 may have additional features or functionality. For example, the mobile computing device 1000 may also include additional data storage devices (removable and/or non-removable) such as, magnetic disks, optical disks, or tape. Such additional storage is illustrated in FIG. 10 by the non-volatile storage area 1068.

Data/information generated or captured by the mobile computing device 1000 and stored via the system 1002 may be stored locally on the mobile computing device 1000, as described above, or the data may be stored on any number of storage media that may be accessed by the device via the radio interface layer 1072 or via a wired connection between the mobile computing device 1000 and a separate computing device associated with the mobile computing device 1000, for example, a server computer in a distributed computing network, such as the Internet. As should be appreciated such data/information may be accessed via the mobile computing device 1000 via the radio interface layer 1072 or via a distributed computing network. Similarly, such data/information may be readily transferred between computing devices for storage and use according to well-known data/information transfer and storage means, including electronic mail and collaborative data/information sharing systems.

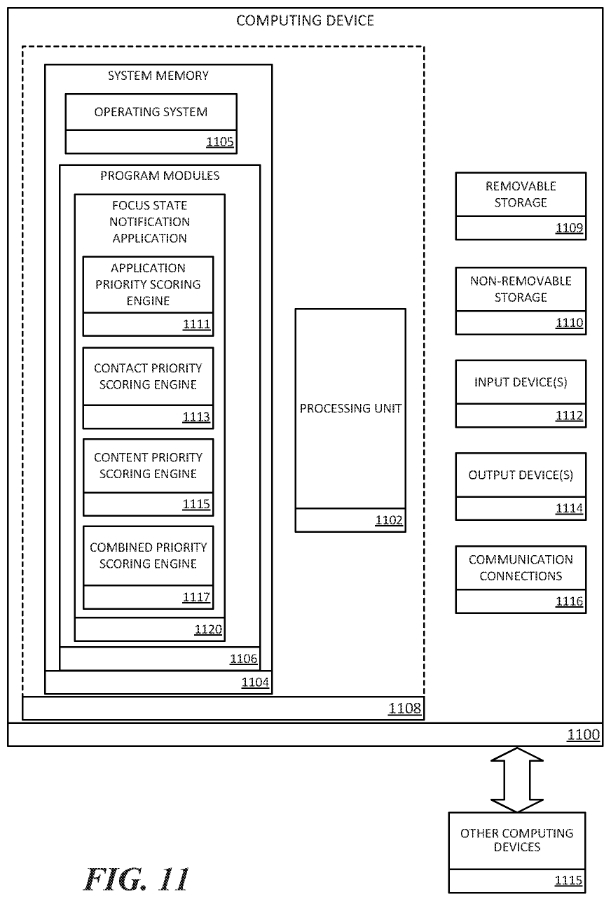

FIG. 11 is a block diagram illustrating physical components (e.g., hardware) of a computing device 1100 with which aspects of the disclosure may be practiced. The computing device components described below may have computer executable instructions for performing operations associated with a focus state notification service as described herein. In a basic configuration, the computing device 1100 may include at least one processing unit 1102 and a system memory 1104. Depending on the configuration and type of computing device, the system memory 1104 may comprise, but is not limited to, volatile storage (e.g., random access memory), non-volatile storage (e.g., read-only memory), flash memory, or any combination of such memories. The system memory 1104 may include an operating system 1105 suitable for running one or more application programs. The operating system 1105, for example, may be suitable for controlling the operation of the computing device 1100. Furthermore, embodiments of the disclosure may be practiced in conjunction with a graphics library, other operating systems, or any other application program and is not limited to any particular application or system. This basic configuration is illustrated in FIG. 11 by those components within a dashed line 1108. The computing device 1100 may have additional features or functionality. For example, the computing device 1100 may also include additional data storage devices (removable and/or non-removable) such as, for example, magnetic disks, optical disks, or tape. Such additional storage is illustrated in FIG. 11 by a removable storage device 1109 and a non-removable storage device 1110.

As stated above, a number of program modules and data files may be stored in the system memory 1104. While executing on the processing unit 1102, the program modules 1106 (e.g., focus state notification application 1120) may perform processes including, but not limited to, the aspects, as described herein. According to examples, application priority scoring engine 1111 may perform one or more operations associated with determining an application priority score for an application associated with an electronic notification and one or more focus states. Contact priority scoring engine 1113 may perform one or more operations associated with determining a contact priority score associated with a sender of a message corresponding to an electronic notification, and/or a publisher of content related to an electronic notification. Content priority scoring engine 1115 may perform one or more operations associated with determining a content priority score for textual content associated with an electronic notification (e.g., via application of one or more natural language processing models to textual content). Combined priority scoring engine 1117 may perform one or more operations associated with determining a combined priority score for an electronic notification based on applying one or more functions or models to a notification priority score for an electronic notification and an application priority score for an electronic notification.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 11 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 1100 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 1100 may also have one or more input device(s) 1112 such as a keyboard, a mouse, a pen, a sound or voice input device, a touch or swipe input device, etc. The output device(s) 1114 such as a display, speakers, a printer, etc. may also be included. The aforementioned devices are examples and others may be used. The computing device 1100 may include one or more communication connections 1116 allowing communications with other computing devices 1150. Examples of suitable communication connections 1116 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 1104, the removable storage device 1109, and the non-removable storage device 1110 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1100. Any such computer storage media may be part of the computing device 1100. Computer storage media does not include a carrier wave or other propagated or modulated data signal. Computer storage device does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

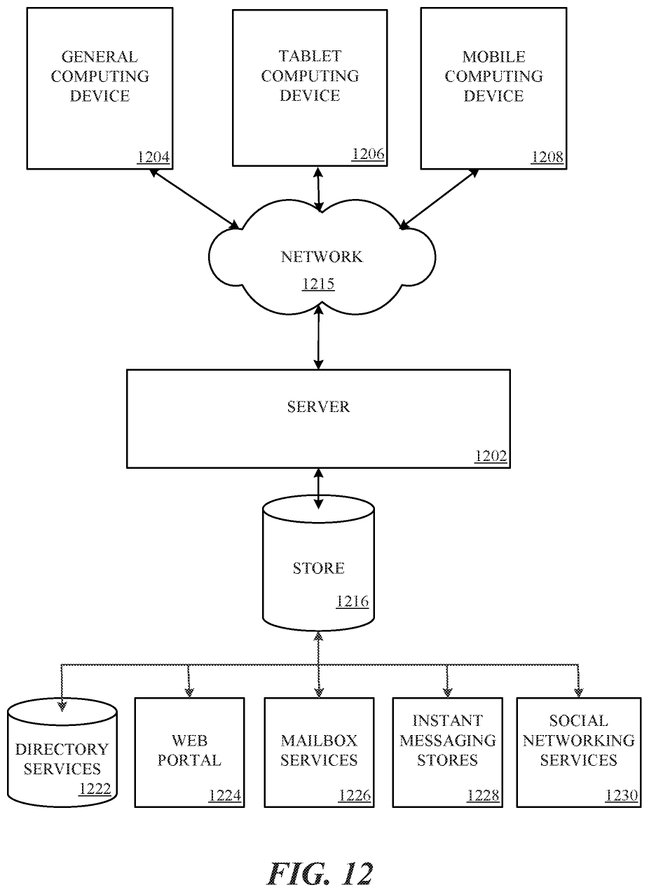

FIG. 12 illustrates one aspect of the architecture of a system for processing data received at a computing system from a remote source, such as a personal/general computer 1204, tablet computing device 1206, or mobile computing device 1208, as described above. Content displayed at server device 1202 may be stored in different communication channels or other storage types. For example, various documents may be stored using a directory service 1222, a web portal 1224, a mailbox service 1226, an instant messaging store 1228, or a social networking site 1230. The program modules 1106 may be employed by a client that communicates with server device 1202, and/or the program modules 1106 may be employed by server device 1202. The server device 1202 may provide data to and from a client computing device such as a personal/general computer 1204, a tablet computing device 1206 and/or a mobile computing device 1208 (e.g., a smart phone) through a network 1215. By way of example, the computer systems described herein may be embodied in a personal/general computer 1204, a tablet computing device 1206 and/or a mobile computing device 1208 (e.g., a smart phone). Any of these embodiments of the computing devices may obtain content from the store 1216, in addition to receiving graphical data useable to be either pre-processed at a graphic-originating system, or post-processed at a receiving computing system.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present disclosure, one skilled in the art may envision variations, modifications, and alternate aspects falling within the spirit of the broader aspects of the general inventive concept embodied in this application that do not depart from the broader scope of the claimed disclosure.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A computer-implemented method for filtering electronic notifications, the computer-implemented method comprising:
managing a first computing device associated with a first user account, and a second computing device associated with the first user account;
determining a current focus state associated with the first user account;
receiving an electronic notification from a first application executed on the first computing device;
determining an application priority score for the first application based, at least in part, on the current focus state;
determining a notification priority score for the electronic notification;
determining a combined priority score from the first application priority score and the notification priority score;
determining that the combined priority score does not meet a threshold surfacing value; and
blocking, based on the combined priority score not meeting the threshold surfacing value, the electronic notification from being surfaced.

2. The computer-implemented method of claim 1, further comprising:
receiving a second electronic notification from a second application executed on the first computing device;
determining a second application priority score for the second application based, at least in part, on the current focus state;
determining a second notification priority score for the second electronic notification;
determining a second combined priority score from the second application priority score and the second notification priority score;
determining that the second combined priority score meets the threshold surfacing value; and
causing, based on the second combined priority score meeting the threshold surfacing value, the second electronic notification to be surfaced.

3. The computer-implemented method of claim 1, wherein the current focus state is one of: a work focus state, a home focus state, and a vacation focus state.

4. The computer-implemented method of claim 3, wherein the current focus state is determined based on at least one of:
a current location of the first computing device;
a current location of the second computing device;
an identity of an application currently being executed by the first computing device; and
an identity of an application currently being executed by the second computing device.

5. The computer-implemented method of claim 1, further comprising maintaining a knowledge base comprising:
a work focus state application priority score for the first application, wherein the work focus state application priority score for the first application comprises a function of interaction of the first user account with the first application in a work focus state;
a home focus state application priority score for the first application, wherein the home focus state application priority score for the first application comprises a function of interaction of the first user account with the first application in a home focus state; and
a vacation focus state application priority score for the first application, wherein the vacation focus state application priority score for the first application comprises a function of interaction of the first user account with the first application in a vacation focus state.

6. The computer-implemented method of claim 5, wherein the application priority score for the first application comprises one of: the work focus state application priority score for the first application; the home focus state application priority score for the first application; and the vacation focus state application priority score for the first application.

7. The computer-implemented method of claim 5, further comprising:
receiving a plurality of interactions from the first user account with the first application; and
modifying, based on the plurality of interactions, the work focus state application priority score.

8. The computer-implemented method of claim 1, further comprising:
maintaining a plurality of work focus state application priority scores for a plurality of applications, wherein each of the plurality of work focus state application priority scores is determined based on a function of the first user account interacting with each corresponding one of the plurality of applications in a work focus state;
maintaining a plurality of home focus state application priority scores for the plurality of applications, wherein each of the plurality of home focus state application priority scores is determined based on a function of the first user account interacting with each corresponding one of the plurality of applications in a home focus state; and
maintaining a plurality of vacation focus state application priority scores for the plurality of applications, wherein each of the plurality of vacation focus state application priority scores is determined based on a function of the first user account interacting with each corresponding one of the plurality of applications in a home focus state.

9. The computer-implemented method of claim 1, further comprising:
determining that combined priority scores for a plurality of electronic notifications do not meet the threshold surfacing value;
blocking each of the plurality of electronic notifications;
receiving an indication to surface blocked electronic notifications; and
surfacing a summary of each of the plurality of electronic notifications in a blocked notification pane.

10. The computer-implemented method of claim 1, wherein determining the notification priority score for the electronic notification comprises:
processing content of the electronic notification with a natural language processing model, wherein the natural language processing model has been trained to calculate textual importance of textual content; and
determining, based on the processing, a textual importance score of the electronic notification.

11. The computer-implemented method of claim 10, wherein the natural language processing model is a string embedding model.

12. The computer-implemented method of claim 10, wherein the natural language processing model comprises at least one of:
a keyword matching model; and
a phrase matching model.

13. The computer-implemented method of claim 10, wherein determining the notification priority score for the content of the electronic notification further comprises:
identifying an identity of a user account associated with a sending user of the electronic notification; and
determining, based on the identification, a contact importance score of the user account associated with the sending user to the first user account.

14. A system for filtering electronic notifications, comprising:
a memory for storing executable program code; and
a processor, functionally coupled to the memory, the processor being responsive to computer-executable instructions contained in the program code and operative to:
manage a first computing device associated with a first user account;
maintain, by the first computing device, a home focus pane and a work focus pane;
determine that the first user account is currently in a work focus state;
receive an electronic notification from a first application;
determine a work focus state application priority score for the first application;
determine a notification priority score for the electronic notification;
determine a combined work focus state priority score for the electronic notification, wherein the combined work focus state priority score is calculated from the work focus state application priority score for the first application and the notification priority score for the electronic notification;
determine that the combined work focus state priority score for the electronic notification meets a threshold surfacing value for the work focus state; and
cause, based on the combined work focus state priority score for the electronic notification meeting the threshold surfacing value, the electronic notification to be surfaced in the work focus pane.

15. The system of claim 14, wherein the processor is further responsive to the computer-executable instructions contained in the program code and operative to:
receive a second electronic notification from a second application;
determine a second work focus state application priority score for the second application;
determine a second notification priority score for the second electronic notification;
determine a second combined work focus state priority score for the second electronic notification, wherein the second combined work focus state priority score is calculated from the second work focus state application priority score for the second application and the second notification priority score for the second electronic notification;
determine that the second combined work focus state priority score for the second electronic notification is below the threshold surfacing value for the work focus state; and
cause, based on the second combined work focus state priority score being below the threshold surfacing value, the second electronic notification to be surfaced in the home focus pane.

16. The system of claim 14, wherein in determining the notification priority score for the electronic notification, the processor is further responsive to the computer-executable instructions contained in the program code and operative to:
process content of the electronic notification with a natural language processing model, wherein the natural language processing model has been trained to calculate textual importance of textual content; and
determine, based on the processing, a textual importance score of the electronic notification.

17. The system of claim 16, wherein in determining the notification priority score for the electronic notification, the processor is further responsive to the computer-executable instructions contained in the program code and operative to:
identify an identity of a user account associated with a sending user of the electronic notification; and
determine, based on the identification, a contact importance score of the user account associated with the sending user to the first user account.

18. A computer-readable storage device comprising executable instructions that, when executed by a processor, assists with filtering electronic notifications, the computer-readable storage device including instructions executable by the processor for:
managing a first computing device associated with a first user account, and a second computing device associated with the first user account, wherein the second computing device is executing a device mirroring application;
determining a current focus state associated with the first user account;
receiving an electronic notification from a first application executed on the first computing device;
determining an application priority score for the first application based, at least in part, on the current focus state;
determining a notification priority score for the electronic notification;
determining a combined priority score from the first application priority score and the notification priority score;
determining that the combined priority score is below a threshold surfacing value; and
blocking, based on the combined priority score being below the threshold surfacing value, the electronic notification from being surfaced by the device mirroring application on the second computing device.

19. The computer-readable storage device of claim 18, wherein the instructions are further executable by the processor for:
receiving a second electronic notification from a second application executed on the first computing device;
determining a second application priority score for the second application based, at least in part, on the current focus state;
determining a second notification priority score for the content of the second electronic notification;
determining a second combined priority score from the second application priority score and the second notification priority score;
determining that the second combined priority score meets the threshold surfacing value; and
causing, based on the second combined priority score meeting the threshold surfacing value, the second electronic notification to be surfaced by the device mirroring application on the second computing device.

20. The computer-readable storage device of claim 18, wherein the instructions are further executable by the processor for:
maintaining a work focus state application priority score for the first application, wherein the work focus state application priority score for the first application comprises a function of interaction of the first user account with the first application in a work focus state;
maintaining a home focus state application priority score for the first application, wherein the home focus state application priority score for the first application comprises a function of interaction of the first user account with the first application in a home focus state; and
maintaining a vacation focus state application priority score for the first application, wherein the vacation focus state application priority score for the first application comprises a function of interaction of the first user account with the first application in a vacation focus state.
